(19) United States
(12) Patent Application Publication
(10) Pub. No.: US 2017/0168321 A1
(43) Pub. Date: Jun. 15, 2017

(54) EYEGLASSES HAVING MULTI-PURPOSE LENS-EXTENDING PORTION

(71) Applicant: Kawamoto Optical Industrial Co., Ltd., Osaka (JP)

(72) Inventor: Shuichi KAWAMOTO, Osaka (JP)

(21) Appl. No.: 15/088,176

(22) Filed: Apr. 1, 2016

(30) Foreign Application Priority Data
Dec. 15, 2015 (JP) JP2015-243788

(51) Int. Cl. G02C 11/00; G02C 11/02; G02C 11/08; G02C 1/04

(52) U.S. Cl. CPC G02C 11/00; G02C 1/04; G02C 11/02; G02C 11/08

(57) ABSTRACT

The present invention provides eyeglasses (1) having left and right lenses (3) that are rimless at least in a lower half thereof wherein at least one lens-extending portion (5 to 5F) formed as a member separate from the left and right lenses (3) is attached to the eyeglasses so as to extend outward directly from each of the left and right lenses. The lens-extending portion (5 to 5F) is used for various purposes such as ornamentation, ventilation, flow control, and the like.

### FIELD OF THE INVENTION

The present invention relates to eyeglasses having an extending portion extending outward directly from a lens. This extending portion is used for various purposes such as ornamentation, ventilation, flow control, and the like.

### BACKGROUND OF THE INVENTION

For eyeglasses having an extending portion extending outward directly from a lens, the following techniques are known:

(1) JP H10-307281A: Treating a partial region of lens faces to form a rough face, and painting that region, thereby obtaining an ornamental portion;

(2) JP 2000-318395A: Fixing a magnet to a back side of eyeglass lenses, and placing a magnet to a front side and attaching an ornamental member to the magnet on the front side; and

(3) Japanese Utility Model Registration No. 3108070: Fixing a plurality of ornamental pieces in a row near eyeglass lenses.

According to Document (1), the design cannot be changed because the main body lenses and the extending portion are made of the same material. According to Document (2), the extending portion extends in the front-rear direction of the lenses, not outward from a side of the lenses. According to Document (3), the ornamental pieces are linked in a row, and, thus, each ornamental piece is very small and cannot be used for purposes other than ornamentation.

### SUMMARY OF THE INVENTION

It is an object of the present invention to allow a relatively large extending portion formed as a member separate from main body lenses to be detachably attached to the main body lenses at a position where the field of view is not affected much, and use the extending portion for various purposes.

In order to solve the above-described problems, the present invention is directed to eyeglasses having left and right lenses that are rimless at least in a lower half thereof wherein at least one multi-purpose lens-extending portion formed as a member separate from the left and right lenses is attached to the eyeglasses so as to extend outward directly from the left or right lens. The left and right lenses may be integrally formed.

It is preferable that the at least one lens-extending portion is provided at each of a position on a left side of the left lens and below an end piece, and a position on a right side of the right lens and below an end piece.

The lens-extending portion may have an ornament such as a text character or a pattern.

The lens-extending portion may be provided with a through-hole for ventilation. The ventilation hole may be parallel to a thickness direction of the lens-extending portion, or may be inclined with respect to that direction. The lens-extending portion may be provided with the ventilation hole together with one of a protrusion and a raised portion for facilitating control of flow toward the ventilation hole.

According to the present invention, a relatively large lens-extending portion formed as a separate member can be attached to a position where the field of view of a wearer is not obstructed. Thus, it is possible to use the extending portion for ornamentation, ventilation, flow control, and the like. The lens-extending portion is formed as a member separate from the lenses, and, thus, it can be replaced or changed.

### BRIEF DESCRIPTION OF THE DRAWINGS

Hereinafter, embodiments of the present invention will be described with reference to the attached drawings.

FIG. 1 is a perspective view of eyeglasses that have lens-extending portions according to Embodiment 1.

FIG. 2(a) shows a perspective view of a method for attaching a lens-extending portion according to Embodiment 1, and FIG. 2(b) is a cross-sectional view taken along the line indicated by the arrows in FIG. 2(a).

FIG. 3(a) shows a perspective view of another method for attaching the lens-extending portion according to Embodiment 1, and FIG. 3(b) is a cross-sectional view taken along the line indicated by the arrows in FIG. 3(a).

FIG. 4(a) is a perspective view showing a lens-extending portion according to Embodiment 2, and FIG. 4(b) is a cross-sectional view taken along the line indicated by the arrows in FIG. 4(a).

FIG. 5(a) is a perspective view showing a lens-extending portion according to Embodiment 3, and FIG. 5(b) is a cross-sectional view taken along the line indicated by the arrows in FIG. 5(a).

FIG. 6(a) is a perspective view showing a lens-extending portion according to Embodiment 4, and FIG. 6(b) is a cross-sectional view taken along the line indicated by the arrows in FIG. 6(a).

FIG. 7(a) is a perspective view showing a lens-extending portion according to Embodiment 5, and FIG. 7(b) is a cross-sectional view taken along the line indicated by the arrows in FIG. 7(a).

FIG. 8(a) is a perspective view showing a lens-extending portion according to Embodiment 6, and FIG. 8(b) is a cross-sectional view taken along the line indicated by the arrows in FIG. 8(a).

### DETAILED DESCRIPTION OF THE PREFERRED EMBODIMENTS

### Embodiment 1

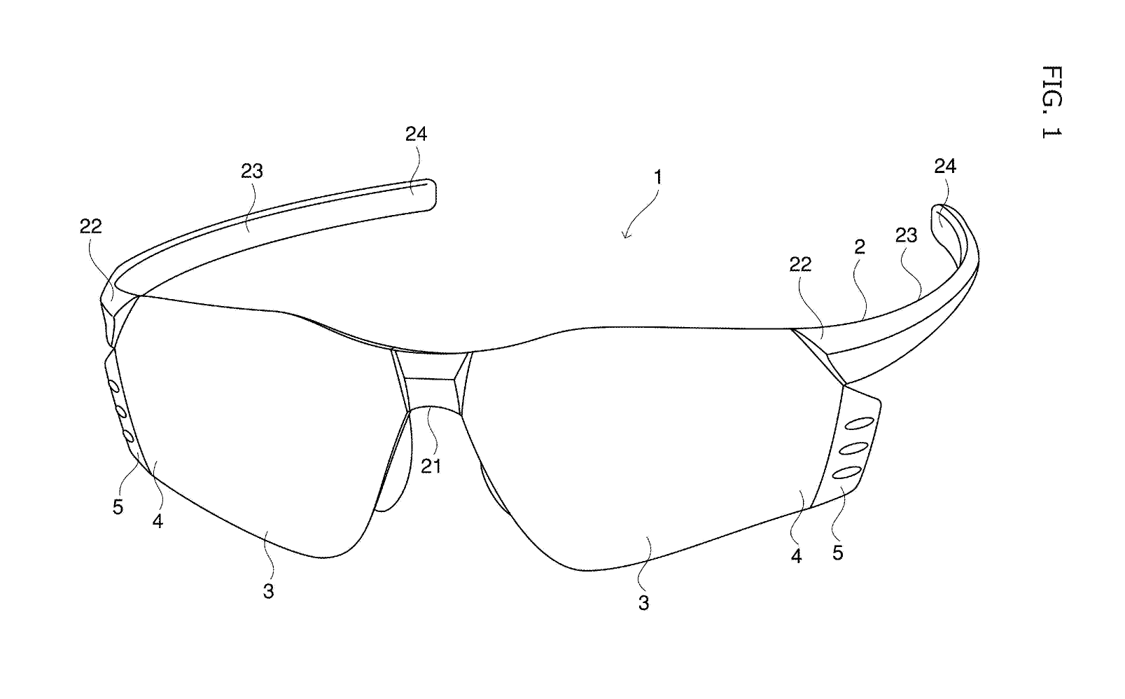

In FIGS. 1 to 4(b), eyeglasses 1 of this embodiment include a frame 2 and lenses 3. The frame 2 includes a bridge 21, end pieces 22, temples 23, and temple tips 24.

The frame 2 and the lenses 3 are made of a synthetic resin. The frame 2 and the lenses 3 may be integrally formed with a synthetic resin, but the lenses 3 are preferably formed with a synthetic resin as separate members that are fitted into the frame 2 for good aesthetics. The left and right lenses 3 may be integrally formed. There is no particular limitation on the synthetic resin, and examples thereof include polycarbonate-based resin, polyolefin-based resin, polyester-based resin, polystyrene-based resin, acrylic-based resin, and the like.

In the drawings, the eyeglass lenses 3 are rimless, and one straight attachment portion 4 is provided at each of a position on a left side of the left lens and below the end piece 22, and a position on a right side of the right lens and below the end piece 22. The attachment portions 4 are respectively provided with lens-extending portions 5. The lens-extending portions 5 extend outward by a distance of preferably about 10 to 30 mm, and more preferably about 15 to 20 mm.

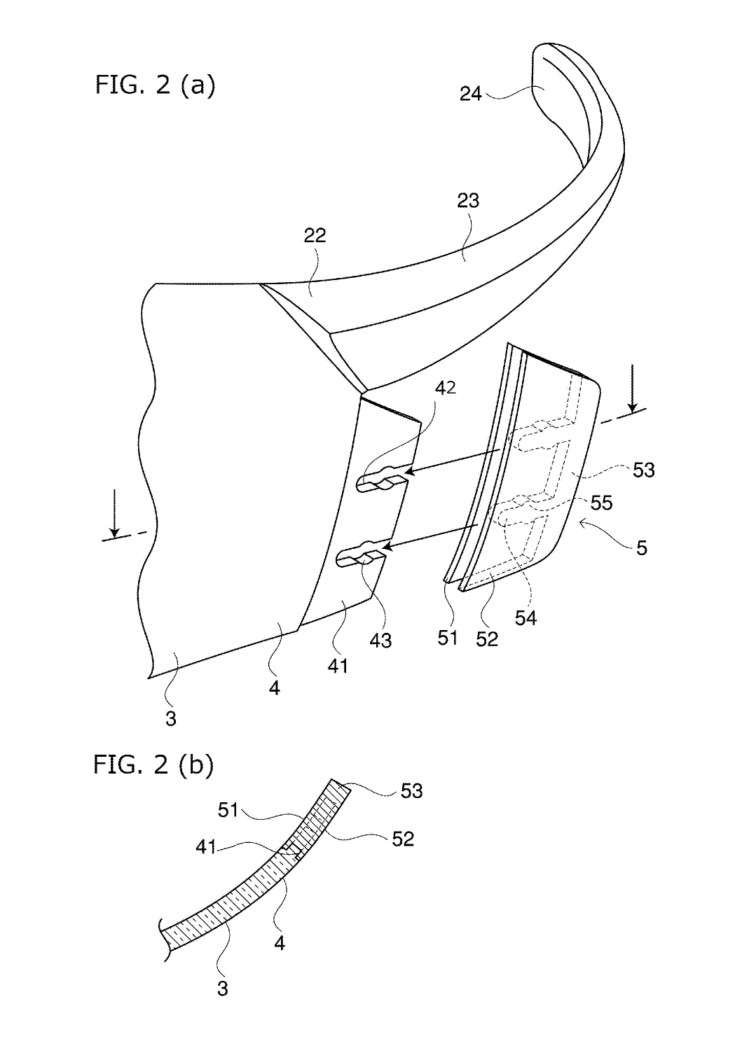

FIG. 2(a) is a perspective view showing a method for attaching each lens-extending portion 5. A lens-projecting portion 41 is provided with a plurality of elongated slits 42 (two elongated slits in FIG. 2(a)) from the outside toward the lens 3. Middle portions of the slits 42 respectively have wide portions 43 where the slit width partially becomes large. The lens-extending portion 5 has a structure in which two wall plates 51 and 52 are joined to each other at their end 53 on the outer side. Protrusions 54 having a shape complementary to the shape of the slits 42 are formed between the wall plates 51 and 52. Middle portions of the protrusions 54 respectively have bulged portions 55.

As shown in FIG. 2(b), if the lens-extending portion 5 is fitted onto the lens-projecting portion 41 in the manner of placing a cover thereover from the outside, the protrusions 54 of the lens-extending portion 5 are fitted into the slits 42 of the lens-projecting portion 41, and the bulged portions 55 are fitted to the wide portions 43, so that the lens-extending portion 5 is tightly joined to the lens-projecting portion 41.

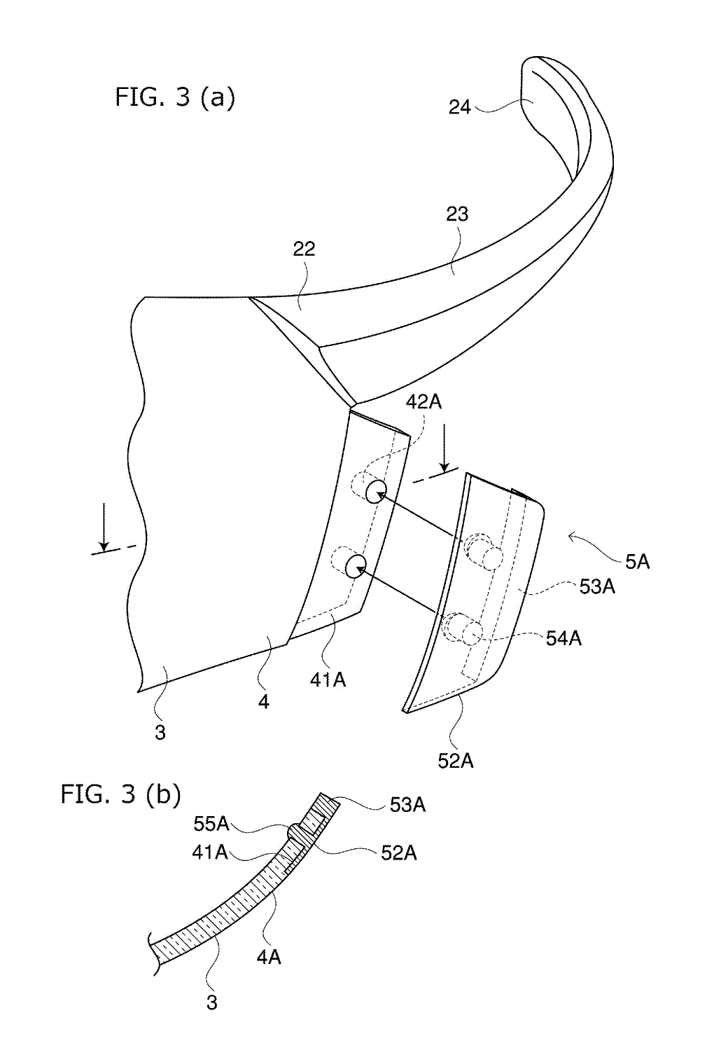

FIG. 3(a) shows a perspective view of another attachment method. A lens-projecting portion 41A is provided with a plurality of through-holes 42A (two through-holes in FIG. 3(a)). A lens-extending portion 5A has a structure in which one wall 52A is supported by an end 53A on the outer side. Protrusions 54A having a shape complementary to the shape of the through-holes 42A are formed on the wall of the lens-extending portion 5A. Ends of the protrusions 54A are respectively provided with stoppers 55A.

As shown in FIG. 3(b), if the lens-extending portion 5A is fitted onto the lens-projecting portion 41A in the manner of placing a cover thereover from the outside, the protrusions 54A of the lens-extending portion 5A are fitted into the through-holes 42A of the lens-projecting portion 41A so that the lens-extending portion 5A is tightly joined to the lens-projecting portion 41A.

In addition to the description above, joining by welding or joining using an adhesive are also possible.

The lens-extending portions 5 and 5A attached in this manner to the lenses 3 are used for various purposes.

### Embodiment 2

In the case of conventional eyeglasses, ornamenting lenses may obstruct the field of view, and, thus, it is not actively performed except for special cases.

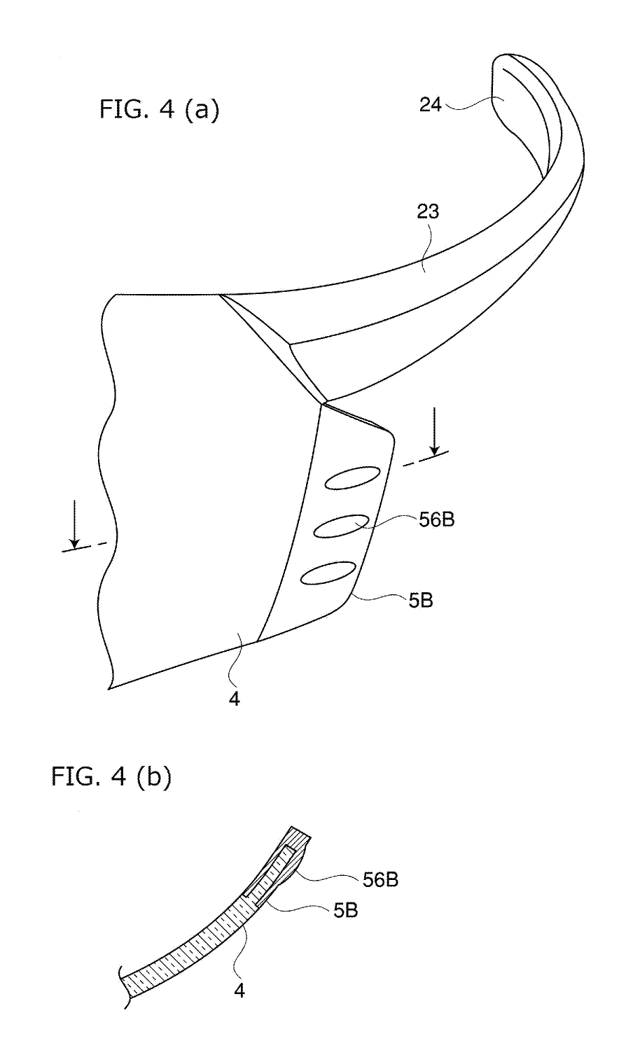

In Embodiment 2 in FIGS. 4(a) and 4(b), a lens-extending portion 5B is provided with three protrusions 56B each in the shape of an elongated hemisphere for ornamental purposes. Ornaments provided on the lens-extending portion 5B are unlikely to obstruct the field of view, and, thus, it is possible to arrange various patterns or text characters over a considerably wide area.

### Embodiment 3

In the case of conventional eyeglasses, especially eyeglasses in which lower edge portions of lenses are curved toward the face of a wearer or side edge portions of the lenses are curved rearward, the amount of air held between the lenses and the face of the wearer is relatively small. Thus, when eyeglasses having such a design are worn during active sports such as skiing or cycling sports, moist air cannot be sufficiently circulated, and thus the eyeglass surfaces on the inner side tend to mist up.

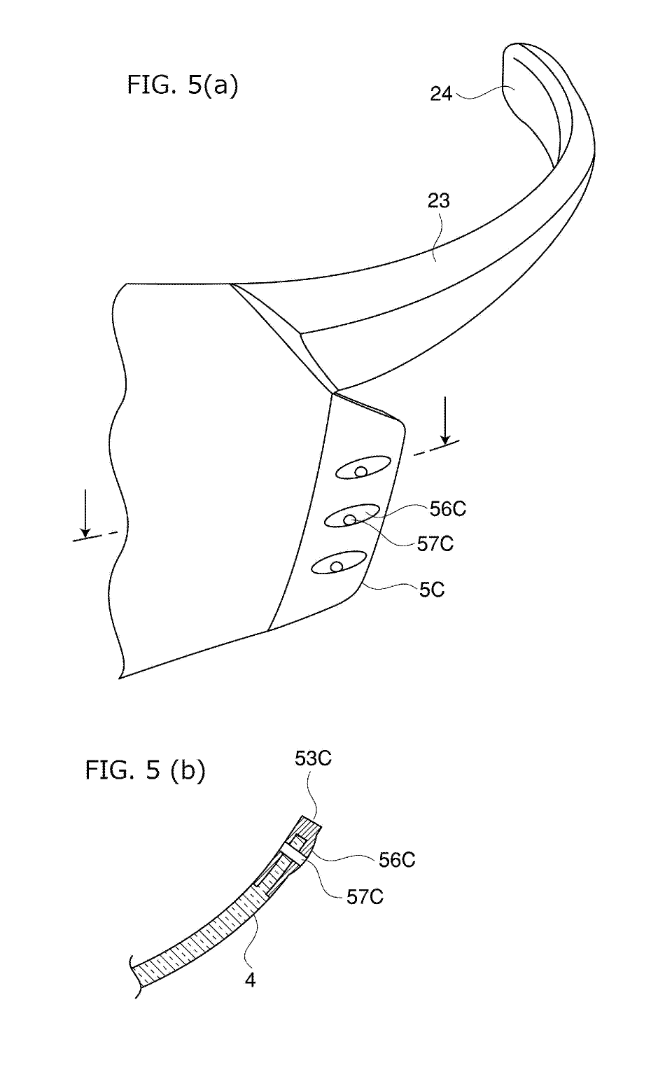

In Embodiment 3 in FIGS. 5(a) and 5(b), protrusion portions 56C each in the shape of an elongated hemisphere as in Embodiment 2 are provided with ventilation holes 57C parallel to a thickness direction of the lens. With the ventilation holes 57C, air circulation is facilitated, and, thus, misting up of the eyeglass surfaces on the inner side is reduced.

### Embodiment 4

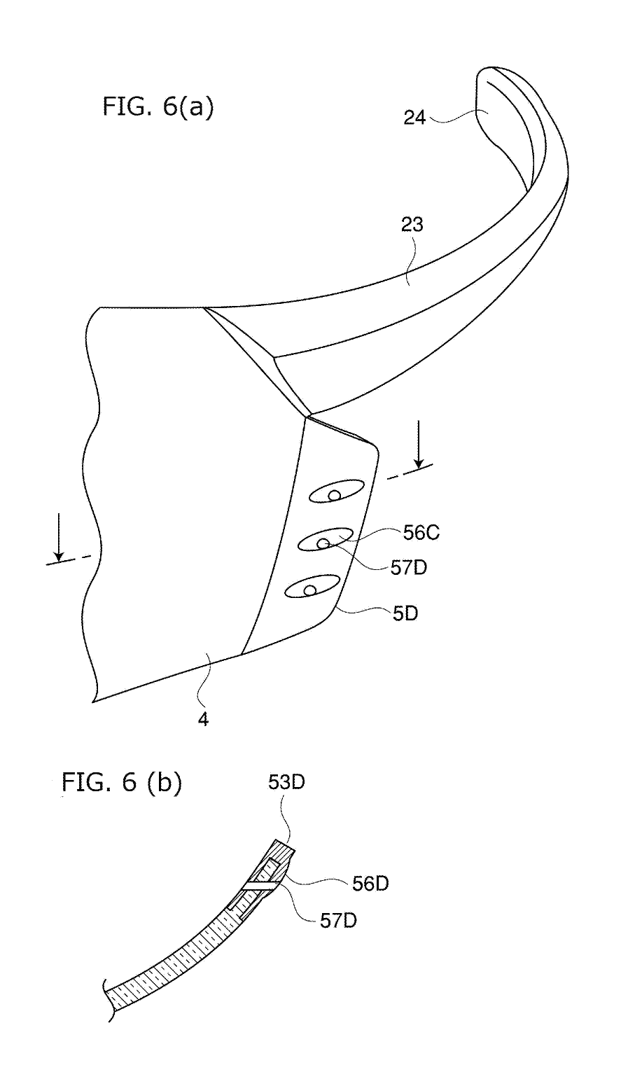

In Embodiment 4 in FIGS. 6(a) and 6(b), ventilation holes 57D of the same type as in Embodiment 3 are inclined toward the inner side of the lens. With such an inclination, air flow can be actively controlled.

### Embodiment 5

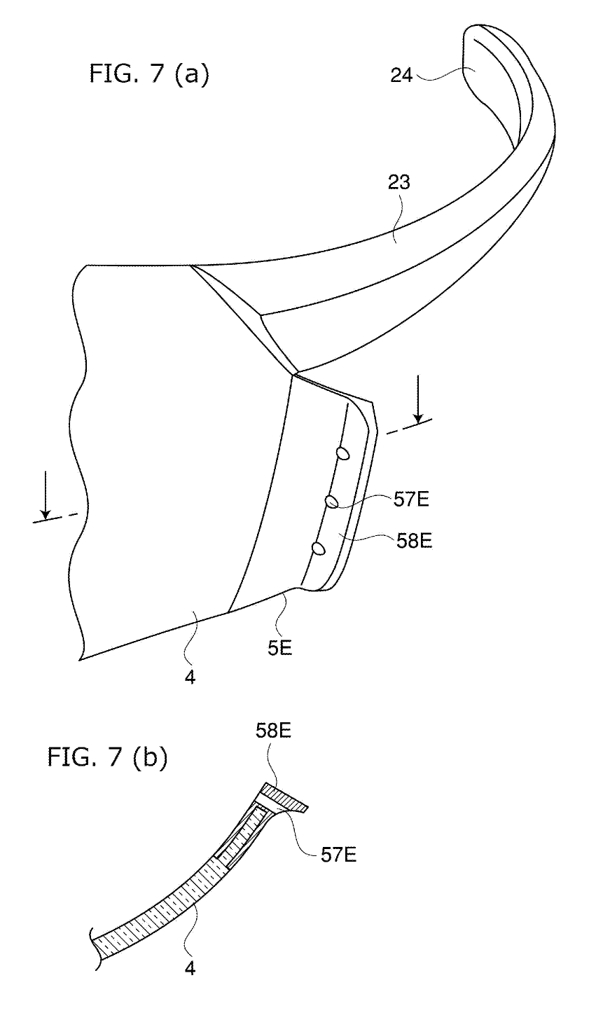

In Embodiment 5 in FIGS. 7(a) and 7(b), an end of a lens-extending plate stands upright to the front side at a portion thereof adjacent to perpendicular ventilation holes 57E. This upright portion 58E forms a wall and facilitates control of air flow toward the ventilation holes 57E.

### Embodiment 6

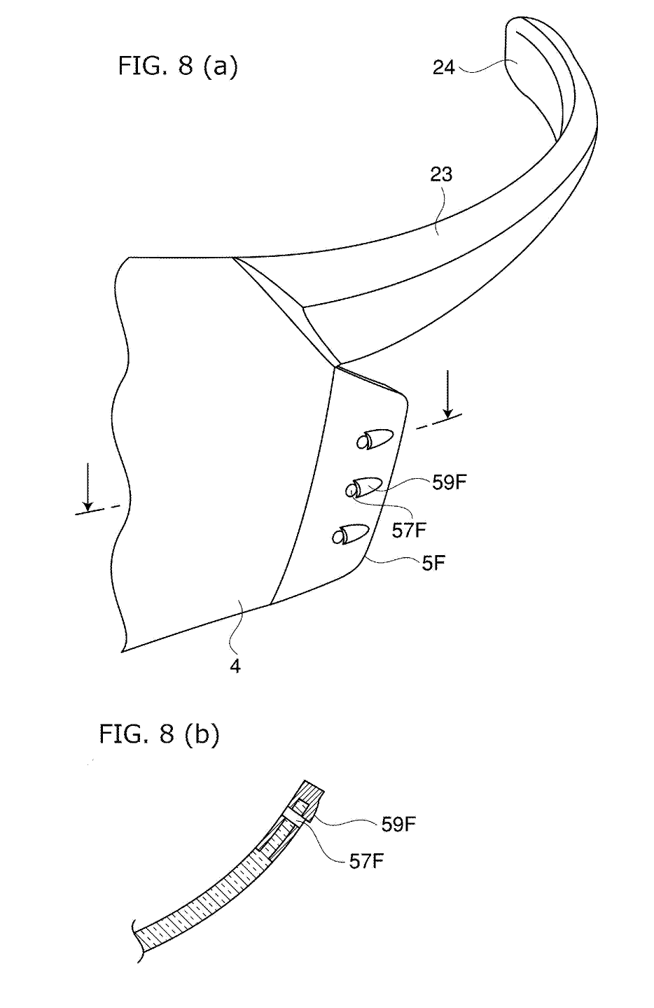

In Embodiment 6 in FIGS. 8(a) and 8(b), a front wall of a lens-extending plate 5F is raised at portions thereof adjacent to perpendicular ventilation holes 57F. These raised portions 59F form walls and facilitate control of air flow toward the ventilation holes 57F.

### LIST OF REFERENCE NUMERALS

1 Eyeglasses
2 Frame
21 Bridge
22 End piece
23 Temple
24 Temple tip
3 Left and right lenses
4 Attachment portion
41, 41A Lens-projecting portion
42 Slit
42A Through-hole
43 Wide portion
5 to 5F Lens-extending portion
51, 52 Wall plate
52A Wall
53 End on outer side
53A End on outer side
54 Protrusion
54A Protrusion
55 Bulged portion
56B Protrusion (ornament)
56C Protrusion portion
57C, 57D, 57E, 57F Through-hole (ventilation hole)
58E Upright portion
59F Raised portion

What is claimed is:

1. Eyeglasses having left and right lenses that are rimless at least in a lower half thereof, wherein at least one multi-purpose lens-extending portion formed as a member separate from the left and right lenses is attached to the eyeglasses so as to extend outward directly from the left or right rimless lens.

2. The eyeglasses according to claim 1, wherein the at least one lens-extending portion is provided at each of a position on a left side of the left lens and below an end piece, and a position on a right side of the right lens and below an end piece.

3. The eyeglasses according to claim 1, wherein the lens-extending portion has an ornament such as a text character or a pattern.

4. The eyeglasses according to claim 1, wherein the lens-extending portion is provided with a through-hole for ventilation.

5. The eyeglasses according to claim 4, wherein the ventilation hole is parallel to a thickness direction of the lens-extending portion.

6. The eyeglasses according to claim 4, wherein the ventilation hole is inclined with respect to a thickness direction of the lens-extending portion.

7. The eyeglasses according to claim 4, wherein the lens-extending portion is provided with the ventilation hole together with one of an upright portion and a raised portion for facilitating control of flow toward the ventilation hole.

8. The eyeglasses according to claim 1, wherein the lens-extending portion extends outward by a distance of 10 to 30 mm.

9. The eyeglasses according to claim 1, wherein the left or right rimless lens has a lens-projecting portion and the lens-extending portion is fitted onto the lens-projecting portion in a manner of placing a cover thereover from an outside.
